(19) United States
(12) Patent Application Publication
(10) Pub. No.: US 2006/0168658 A1
(43) Pub. Date: Jul. 27, 2006

(54) Protection of data to be stored in the memory of a device

(75) Inventor: Visa Kallio, Oulu (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/320,174

(22) Filed: Dec. 27, 2005

(30) Foreign Application Priority Data
Dec. 29, 2004 (FI) 20045505

(51) Int. Cl. G06F 12/14

(52) U.S. Cl. 726/21

(57) ABSTRACT

A method for defining the rights of access to user-specific data to be stored in the memory (MEM) of a communication device (1), which communication device comprises a user-specific authentication module (SIM) with an individual identification code. In connection with the storing of the data, the protection of the data is arranged on the basis of the identification code of the authentication module (SIM), wherein the data stored in the memory (MEM) of the device (1) is only accessible by using the identification code for the authentication module used for the storing of the data. Furthermore, the invention relates to a corresponding communication device, a computer program, and a software product.

### CROSS-REFERENCE TO RELATED APPLICATIONS

This application claims priority under 35 USC §119 to Finnish Patent Application No. 20045505 filed on Dec. 29, 2004.

### FIELD OF THE INVENTION

The invention relates to a method for protecting data to be stored in the memory of a communication device. Furthermore, the invention relates to a communication device, a computer program, as well as a software product.

### BACKGROUND OF THE INVENTION

Individual subscription data, such as phone number data, of a mobile phone and other corresponding communication devices are typically located in a memory module placed in the device, i.e., typically on a SIM card (subscriber identification module). For example, when the phone is delivered to another user, the first owner of the phone can remove the SIM card from the phone, wherein the phone number is changed to correspond to the phone number of the SIM card of the new owner. However, in mobile phones and corresponding communication devices, it is often possible to store various messages, such as SMS (short message service), MMS (multimedia messaging service) and email messages. These messages are normally stored in the memory of the device. When removing the SIM card, the first user must also separately remove the messages stored in the memory of the phone, if he/she wants to make sure that the second user will not be able to read them.

### SUMMARY OF THE INVENTION

Now, a method has been invented to prevent unauthorized reading and use of personal messages after the SIM card of the device has been changed.

According to a first aspect of the present invention, a method is provided for defining rights of access to user-specific data to be stored in the memory of a communication device, which communication device comprises a user-specific authentication module with an individual identification code, by means of which a user is identified in a mobile communication network, wherein in connection with the storing of the data, the protection of the data is arranged on the basis of the identification code of the authentication module, wherein the data stored in the memory of the device is only accessible by using the identification code for the authentication module used for the storing of the data. The user-specific data may be encrypted with an encryption key formed of the identification code of the authentication module before the storing in the memory of the device. The user-specific data may be supplemented with a user-specific identification formed of the identification code of the authentication module before the storing in the memory of the device. The user-specific data may be stored in a data file for which a user-specific identification is formed from the identification code of the authentication module. The device may be selected from various portable devices including a mobile station, a mobile phone, a palm top computer, or a personal digital assistant. The authentication module may be a subscriber identification module, a universal subscriber identity module, or a removable user identity module. The identification code of the authentication module may be an international mobile subscriber identification.

According to a second aspect of the present invention, a communication device comprises a control unit for controlling the function of the device, a memory for storing at least user-specific data, and a user-specific authentication module for identifying the user, which authentication module comprises an individual identification code, by means of which a user is identified in a mobile communication network, wherein the control unit comprises an encryption unit which is adapted to form protection data on the basis of the identification code of the authentication module, the control unit is adapted to protect the user-specific data with the protection data in connection with the storing in the memory of the device, wherein the data stored in the memory of the device can be accessed with the identification code of the authentication module used for the storage of the data. Before the storing in the memory of the device, the control unit may be adapted to encrypt the user-specific data with an encryption key formed at least partly of the identification code of the authentication module. The control unit may be adapted to supplement the user-specific identification with the user-specific identification formed of the identification code of the authentication module before the storing in the memory of the device. The control unit may be adapted to store the user-specific data in a data file in the memory of the device, the file being equipped with a user-specific identification formed of the identification code of the authentication module. The device may be a mobile station, a mobile phone, a palm top computer, a personal digital assistant, or the like. The authentication module may be a subscriber identification module, a universal subscriber identity module, a removable user identity module, or the like. The identification code of the authentication module may be an international mobile subscriber identification code.

According to a third aspect of the present invention, a computer program is provided for defining the rights of access to user-specific data to be stored in the memory of a communication device, which communication device comprises a user-specific authentication module with an individual identification code, by means of which a user is identified in a mobile communication network, wherein the software comprises program instructions, by which, in connection with the storing of the data, the protection of the data is arranged on the basis of the identification code of the authentication module, wherein the data stored in the memory of the device is only accessible by using the identification code for the authentication module used for the storing of the data. The software may comprise program instructions by which the user-specific data is encrypted with an encryption key formed of the identification code of the authentication module before the storage in the memory of the device. The software may comprise program instructions by which the user-specific data is supplemented with a user-specific identification formed of the identification code of the authentication module before the storage in the memory of the device. The software may comprise program instructions by which the user-specific data is stored in a data directory equipped with a user-specific identification from the identification code of the authentication module. A software product may provided comprising a memory means for storing a computer program according the to third aspect of the present invention. The software product may be arranged to be run in a mobile station, a mobile phone, a palm top computer, a personal digital assistant, or the like.

The invention relates to a method for defining the rights of access to user-specific data to be stored in the memory of a communication device, which communication device comprises a user-specific authentication module with an individual identification code, by means of which a user is identified in a mobile communication network, wherein in connection with the storing of the data, the protection of the data is arranged on the basis of the identification code of the authentication module, wherein the data stored in the memory of the device is only accessible by using the identification code for the authentication module used for the storing of the data.

The communication device comprises a control unit for controlling the function of the device, a memory for storing at least user-specific data, a user-specific authentication module for identifying the user, which authentication module comprises an individual identification code, by means of which a user is identified in a mobile communication network, wherein the control unit comprises an encryption unit which is adapted to form protection data on the basis of the identification code of the authentication module, the control unit is adapted to protect the user-specific data with the protection data in connection with the storing in the memory of the device, wherein the data stored in the memory of the device can be accessed with the identification code of the authentication module used for the storage of the data.

In addition, the invention relates to a computer program for defining the rights of access to user-specific data to be stored in the memory of a communication device, which communication device comprises a user-specific authentication module with an individual identification code, by means of which a user is identified in a mobile communication network, wherein the software comprises program instructions, by which, in connection with the storing of the data, the protection of the data is arranged on the basis of the identification code of the authentication module, wherein the data stored in the memory of the device is only accessible by using the identification code for the authentication module used for the storing of the data.

In the method according to the basic idea of the invention, the protection of data is arranged in connection with the storage of user-specific data in the memory of the communication device, on the basis of an individual identification code in an authentication module. The data stored in the memory of the device can be accessed by using the identification code of the authentication module used for storing the data.

In one embodiment of the invention, the user-specific data is encrypted with an encryption key formed of the identification code of the authentication module before the storage in the memory of the device. In another embodiment, the user-specific data is supplemented with a user-specific identification formed of the identification code of the authentication module before the storage in the memory of the device. In a third embodiment of the invention, in turn, the user-specific data is stored in a data file which is equipped with a user-specific identification formed of the identification code of the authentication module. In an advantageous embodiment, the encryption and decryption of the data take place automatically.

In one embodiment, the device is a mobile station, a mobile phone, a palmtop computer, a personal digital assistant, or a combination of any of these. In one embodiment, the software product comprising the computer program to implement the method is adapted to be run in any of the above-mentioned devices.

In one embodiment of the invention, the authentication module is a SIM card (subscriber identification module), a USIM card (universal subscriber identity module) or an R-UIM card (removable user identity module). In one embodiment, the identification code of the authentication module is an IMSI code (international mobile subscriber identification).

In one embodiment, the right to read and access user-specific data, such as various messages, calendar data and settings, is confirmed on the basis of the SIM card used in the device. If the SIM card and the specific IMSI code match with the user data for the information in the memory of the device, the device will allow the reading and use of the information. If the SIM card and its specific IMSI code do not match with the user data for the information in the memory of the device, the device will not allow the reading and use of the information. In one embodiment, it is possible to switch the checking of the user data on and off separately, wherein it is possible, for example, to utilize messages upon changing the SIM card.

The arrangement according to the invention prevents efficiently the access to the user-specific data by other persons than the authorized user. The invention is advantageous e.g. when the device is delivered or falls to the hands of another user without emptying the memory of the device. The invention makes it possible to deliver the device to another user without a need to remove the personal data of the first user stored in the memory to prevent the use of the data. Thus, the first user can utilize the personal data in the memory of the device again later.

Another embodiment of the invention, in turn, makes it possible to protect user-specific data without requiring separate measures to be taken by the user. For example, the device can be set to protect all the data stored therein or all the data stored in a personal data file.

According to one embodiment of the invention, by using the SIM card and the individual identification therein, the protection can be made individual and thereby difficult to breach. Furthermore, the use of a ready-made authentication module, such as a SIM card, does not require new additional components or identification numbers for the user or the device.

### BRIEF DESCRIPTION OF THE DRAWINGS

In the following, the invention will be described in more detail with reference to the appended principle drawings, in which

FIG. 1 shows an assembly of the device in a block diagram,

FIGS. 2 and 3 show an embodiment of the invention in a flow chart,

FIGS. 4 and 5 show another embodiment of the invention in a flow chart, and

FIGS. 6 and 7 show a third embodiment of the invention in a flow chart.

For the sake of clarity, the figures only show the details necessary for understanding the invention. The structures and details that are not necessary for understanding the invention but will be evident for anyone skilled in the art have been omitted from the figures to emphasize the characteristics of the invention.

### DETAILED DESCRIPTION OF THE INVENTION

The example is a mobile station with a SIM card (subscriber identification module). The SIM card normally contains not only the subscriber's international phone number but also other user and network specific data, such as the user's short numbers, a password to prevent misuse (PIN code, personal identification number), and the international identifications for interconnected networks. The IMSI code (international mobile subscriber identification) on the SIM card is used in the example, in connection with the description of the protection.

In addition to the mobile station given in the example, the device may also be another device in which a user-specific unit can be inserted. This unit contains an individual identification which can be used according to the idea of the invention. The type of the user-specific unit will depend on the application, but in typical mobile station applications it may be, for example, a SIM card, a USIM card (universal subscriber identity module), or a R-UIM card (removable user identity module).

In the example, the item to be protected is called user-specific data (personal data). Such data may be, for example, SMS (short message service), MMS (multimedia messaging service), an email message, or calendar information, but the invention is also suitable for protecting other data.

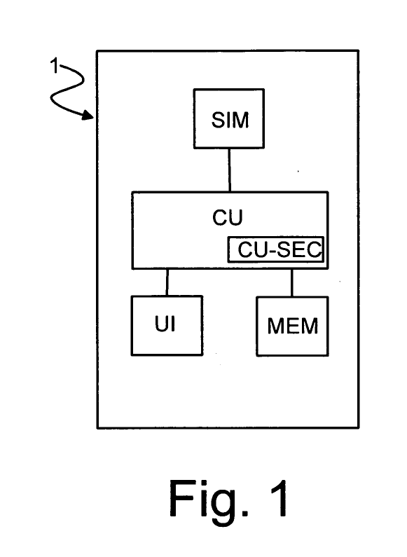

FIG. 1 is a skeleton view of the assembly of a device 1. The device 1 comprises a control unit CU which is arranged to control data transmission and the function of the device. The control unit CU of FIG. 1 also comprises an encryption unit CU-SEC which substantially implements the formation of the encryption key and/or the user-specific identification to be used for protecting data according to the invention. Furthermore, the device 1 comprises a user interface UI for using the device. In the example, the control unit CU is connected to a memory MEM, in which e.g. the user-specific data is stored. The parts of the device 1 shown separately in FIG. 1 may be integrated in each other and/or in other parts of the device. The functions may also be implemented in a variety of ways, for example by programming. For example, in one embodiment, the encryption unit CU-SEC is implemented by programming in the control unit CU. FIG. 1 also shows a SIM card SIM which is connected to the control unit CU when the SIM card is in the device 1.

In the following, three embodiments of the invention will be presented as examples. In the first embodiment, the user's identification is used in connection with all user-specific data. In the second embodiment, the user's identification is used in connection with a user-specific data set. In the third embodiment, in turn, encrypted user-specific data is formed. The device 1 starts the protected entry of user-specific data when the use of protection is required in the settings of the device. In one case, the requirement for using protection is recognized from the data on the receiver/user of the information, wherein the information intended for the receiver/user in question is automatically encrypted. For example, encryption may have been defined to be implemented for all so-called personal data. In another case, the encryption and decryption of data takes place automatically when it is detected, on the basis of the data relating to the SIM card identifying the user, that the data has been set to be protected. Thus, the same module (i.e., the SIM card in the example) is used as an essential element both for identifying the user and for the encryption. On the other hand, an application may provide the user with the option to protect the user-specific information or not.

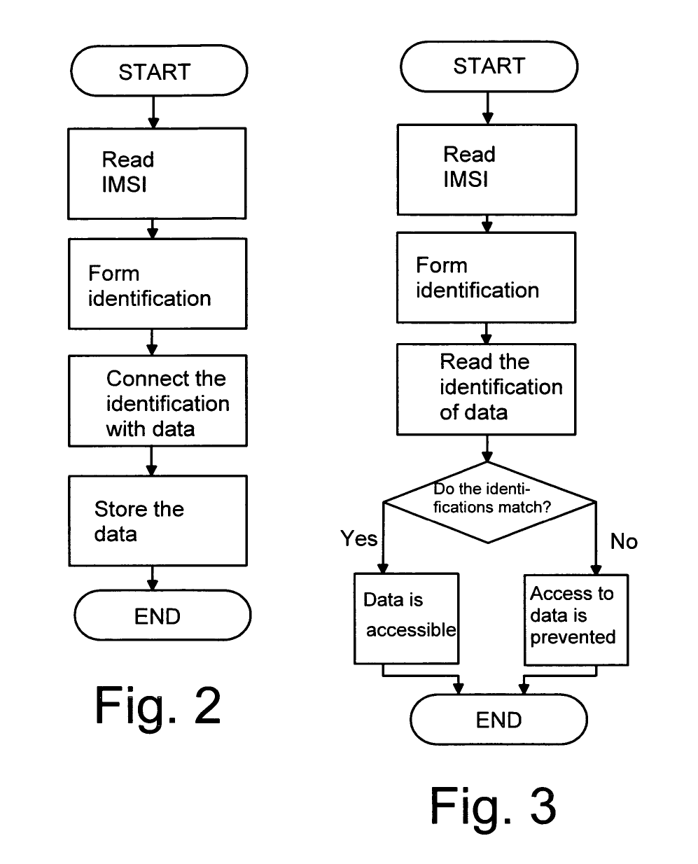

FIG. 2 is a flow chart showing the protection of user-specific data, for example a file, according to the first embodiment. In the example, the first step is to find out the IMSI number. This number is used to form a user-specific identification, i.e., in practice, an identification bound to the IMSI number. After this, the identification is connected with the data, and the data (for example a file) is stored.

FIG. 3, in turn, is a flow chart showing the reading of user-specific protected data (file) according to the first embodiment, after the system has recognized that the data has been protected in a user-specific manner. In the example, the first step is to find out the IMSI number. This number is used to form a user-specific identification. The formed identification is compared with the identification of the data (file). If the identifications match, access to the data (file) is allowed. If the identifications do not match, access to the data is prevented.

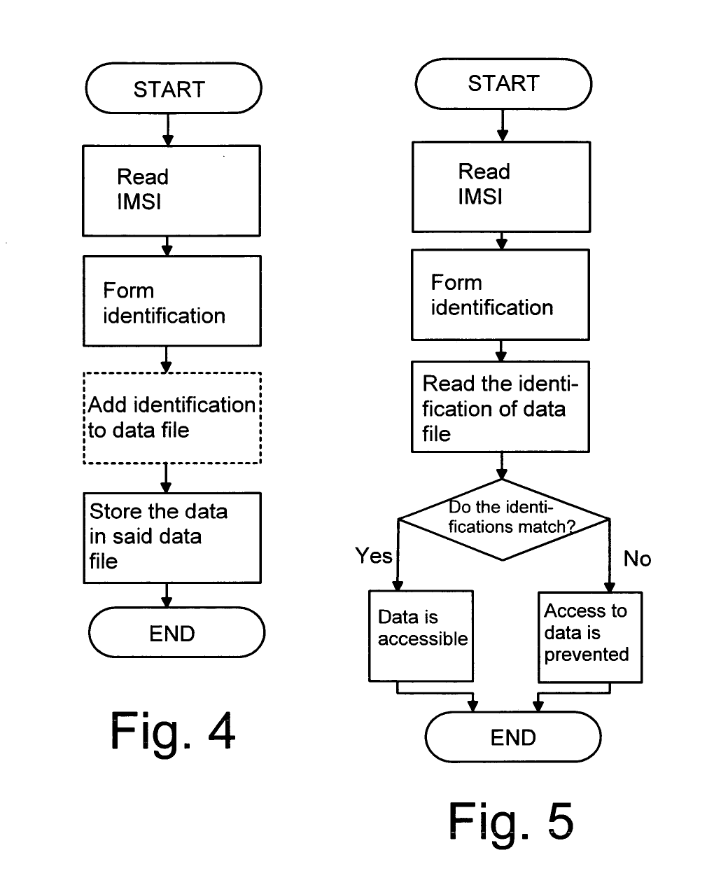

FIG. 4 is a flow chart showing the protection of a user-specific data set according to the second embodiment. In the example, the first step is to find out the IMSI number. This number is used to form a user-specific identification, i.e., in practice, an identification bound to the IMSI number. After this, the data (data set) is stored in a user-specific data file. In one embodiment, a user-specific data file is created if there is no user-specific data file ready.

FIG. 5, in turn, is a flow chart showing the reading of user-specific protected data (data set) according to the second embodiment, after the system has recognized that the data is in a data file protected in a user-specific manner. In the example, the first step is to find out the IMSI number. This number is used to form a user-specific identification. The formed identification is compared with the identification of the user-specific data file. If the identifications match, access to the data is allowed. If the identifications do not match, access to the data is prevented.

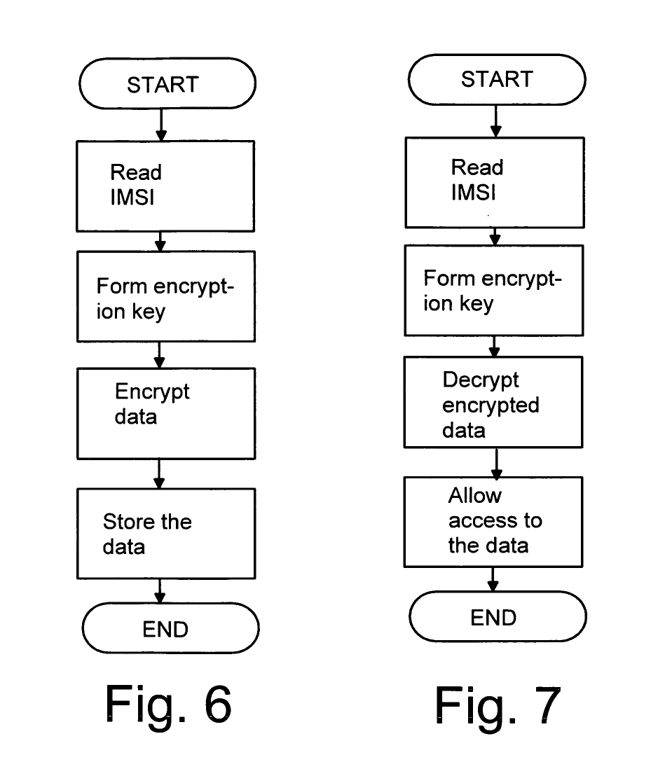

FIG. 6 is a flow chart showing the protection of user-specific data according to the third embodiment. In the example, the first step is to find out the IMSI number. This number is used to form a user-specific encryption key, i.e., in practice, an encryption key bound to the IMSI number. After this, the data is encrypted by using said encryption key. According to the example, it is possible to use a variety of algorithms and methods for the encryption. The encrypted data is stored.

FIG. 7, in turn, is a flow chart showing the reading of user-specific protected data according to the third embodiment, after the system has recognized that the data has been protected in a user-specific manner. In the example, the first step is to find out the IMSI number. This number is used to form a user-specific encryption key. The formed encryption key is used to decrypt the data (file). If the encryption key is correct, the data can be found out.

The encryption key and the user-specific identification used for protecting the data can be formed in a variety of ways. For example, the encryption key or the identification may be based on the whole IMSI code or only a part of it. It is also possible that the encryption key or the user-specific identification are formed by a suitable algorithm on the basis of the IMSI code. Furthermore, it is possible to use more initial data than the IMSI code given in the example, for forming the encryption key or the user-specific identification.

The data and files stored in the memory of the device take up space in the memory of the device. Therefore, it is possible that when the users (i.e., in the example, SIM cards) are changed, so much data is left in the memory of the device that the user cannot store his/her own information in the memory of the device. Depending on the application, the emptying of the memory may be prevented or allowed for a user who has no right of access to the data to be deleted. In one embodiment, user-specific data is erased from the memory after a given term, for example, two months after the user specific for the data has last been detected using the device. The memory can also be emptied as it becomes full (by the first-in-first-out principle), irrespective of the owners of the data. It is also possible to make it more difficult to misuse the data by arranging the data to be erased after exceeding a threshold value set for the number of reading attempts by a user with a false identity. For example, five attempts may be allowed, after which the memory is emptied.

Of the data stored in the memory of the device, some may be protected and some may be unprotected. The format of displaying the data may be used to indicate whether the data is protected or unprotected. For example, for a user with a right to read the data, protected text data may be displayed with a font which is different from the font used for displaying unencrypted data. It is also possible to use various symbols and other identifiers. The existence of protected data may or may not be disclosed to a user with no right to read protected data. For example, in the case of protected data, an identifier, such as a text or a symbol, may be displayed to indicate to the user that the data is protected. In some applications, the existence of protected data is not disclosed to users without the right of access to them.

In view of protecting the user's personal data, it is primarily advantageous that the reading of personal data is only allowed to the authenticated user. In the example, this means that the data stored on a given SIM card can only be read with the SIM card in question. In some situations, however, it may be necessary to have the data available even though the SIM card is changed. Such a situation may occur, for example, when the user changes the operator. The transfer of the user-specific data stored in the memory of the device to be available to another identity may take place in a number of ways. For example, the settings can be changed so that the reading of the data in the memory of the device is allowed for anyone. In another application, in turn, it is possible to define that the reading of the data is allowed with a given SIM card or a password. This could be done for example by having a user who has already been authenticated by means of a first authentication module, such as a first SIM card, indicate that he is about to change SIM cards and then connecting, associating, adding, or encrypting the old data with the new SIM card identification information in such a way that the already stored user-specific data remains accessible to that user. Subsequently added user-specific data is added to, encrypted, connected or associated with the subsequently added data using the new SIM card identification information. In another application, the protection of the data can be defined in a data set and/or a data file specific way.

By combining, in various ways, the modes and structures disclosed in connection with the different embodiments of the invention presented above, it is possible to produce various embodiments of the invention in accordance with the spirit of the invention. Therefore, the above-presented examples must not be interpreted as restrictive to the invention, but the embodiments of the invention may be freely varied within the scope of the inventive features presented in the claims hereinbelow.

1. A method for defining right of access to user-specific data to be stored in a memory of a communication device, which communication device comprises a user-specific authentication module with an individual identification code, by means of which a user is identified in a mobile communication network, wherein in connection with the storing of the data, the method comprises protecting the data based on the identification code of the authentication module, and making the data stored in the memory of the device only accessible by using the identification code for the authentication module used for the storing of the data.

2. The method according to claim 1, wherein the user-specific data is encrypted with an encryption key formed of the identification code of the authentication module before the storing of the data in the memory of the device.

3. The method according to claim 1, wherein the user-specific data is supplemented with a user-specific identification formed of the identification code of the authentication module before the storing in the memory of the device.

4. The method according to claim 1, wherein the user-specific data is stored in a data file for which a user-specific identification is formed from the identification code of the authentication module.

5. The method according to claim 1, wherein the device is at least one of the following: a mobile station, a mobile phone, a palmtop computer, a personal digital assistant.

6. The method according to claim 1, wherein the authentication module is one of the following: a subscriber identification module, a universal subscriber identity module, a removable user identity module.

7. The method according to claim 1, wherein the identification code of the authentication module is an international mobile subscriber identification code.

8. A communication device comprising:
a control unit for controlling a function of the device,
a memory for storing at least user-specific data,
a user-specific authentication module for identifying a user,
which authentication module comprises an individual identification code, by means of which the user is identified in a mobile communication network,
wherein
the control unit comprises an encryption unit which is adapted to form protection data based on the identification code of the authentication module,
the control unit is adapted to protect the user-specific data with the protection data in connection with the storing in the memory, wherein the data stored in the memory can be accessed with the identification code of the authentication module used for the storage of the data.

9. The communication device according to claim 8, wherein before the storing in the memory, the control unit is adapted to encrypt the user-specific data with an encryption key formed at least partly of the identification code of the authentication module.

10. The communication device according to claim 8, wherein the control unit is adapted to supplement the user-specific data with a user-specific identification formed of the identification code of the authentication module before the storing in the memory of the device.

11. The communication device according to claim 8, wherein the control unit is adapted to store the user-specific data in a data file in the memory of the device, the file being equipped with a user-specific identification formed of the identification code of the authentication module.

12. The communication device according to claim 8, wherein the device is at least one of the following: a mobile station, a mobile phone, a palmtop computer, a personal digital assistant.

13. The communication device according to claim 8, wherein the authentication module is one of the following: a subscriber identification module, a universal subscriber identity module, a removable user identity module.

14. The communication device according to claim 8, wherein the identification code of the authentication module is an international mobile subscriber identification.

15. A computer program embodied in a computer readable medium for defining rights of access to user-specific data to be stored in memory of a communication device, which communication device comprises a user-specific authentication module with an individual identification code, by means of which a user is identified in a mobile communication network, wherein the program comprises program instructions, by which, in connection with storing of the data, protection of the data is arranged based on the identification code of the authentication module, wherein data stored in the memory of the device is only accessible by using the identification code for the authentication module used for the storing of the data.

16. The program according to claim 15, wherein the program comprises program instructions, by which the user-specific data is encrypted with an encryption key formed of the identification code of the authentication module before the data is stored in the memory of the device.

17. The program according to claim 15, wherein the program comprises program instructions, by which the user-specific data is supplemented with a user-specific identification formed of the identification code of the authentication module before the data is stored in the memory of the device.

18. The program according to claim 15, wherein the program comprises program instructions, by which the user-specific data is stored in a data directory equipped with a user-specific identification from the identification code of the authentication module.

19. A software product comprising a memory means for storing a computer program according to claim 15.

20. The software product according to claim 19, wherein it is arranged to be run in at least one of the following: a mobile station, a mobile phone, a palmtop computer, a personal digital assistant.
